(19) United States
(12) Patent Application Publication
(10) Pub. No.: US 2026/0221336 A1
(43) Pub. Date: Jul. 30, 2026

(54) MULTILAYER INDUCTOR

(71) Applicant: TDK Corporation, Tokyo (JP)

(72) Inventors: Yusuke NAGAI, Tokyo (JP); Shin TSUKAMOTO, Tokyo (JP); Takumi ITO, Tokyo (JP)

(73) Assignee: TDK Corporation, Tokyo (JP)

(21) Appl. No.: 19/460,984

(22) Filed: Jan. 27, 2026

(30) Foreign Application Priority Data
Jan. 28, 2025 (JP) 2025-012285

(51) Int. Cl. H01F 27/38; H01F 27/00; H01F 27/29

(52) U.S. Cl. CPC H01F 27/38; H01F 27/006; H01F 27/29

(57) ABSTRACT

A multilayer inductor includes: an element body including a plurality of element body layers being laminated; a first coil including a plurality of coil conductors including a first coil conductor, the plurality of coil conductors being directly connected to each other; and a second coil including a plurality of coil conductors including a second coil conductor, the plurality of coil conductors being directly connected to each other. The first coil conductor and the second coil conductor are disposed at a same height position in a lamination direction of the plurality of element body layers.

### TECHNICAL FIELD

The present disclosure relates to a multilayer inductor. This application claims priority based on Japanese Patent Application No. 2025-012285 filed on January 28, 2025, the entire contents of which are incorporated herein by reference.

### BACKGROUND

JP 2010-147416 A discloses an electronic component that includes a laminate in which insulating layers are laminated and two coils embedded in the laminate. In this electronic component, the two coils are arranged in the lamination direction.

### SUMMARY

It is an object of the present disclosure to improve the inductance (L value).

(1) A multilayer inductor according to an embodiment of the present disclosure includes: an element body including a plurality of element body layers being laminated; a first coil including a plurality of coil conductors including a first coil conductor, the plurality of coil conductors being directly connected to each other; and a second coil including a plurality of coil conductors including a second coil conductor, the plurality of coil conductors being directly connected to each other, wherein the first coil conductor and the second coil conductor are disposed at a same height position in a lamination direction of the plurality of element body layers.

In the above multilayer inductor, since the first coil and the second coil overlap in the lamination direction, the inductance can be improved. In a configuration in which a plurality of coil conductors are connected via through-hole conductors, if the through-hole conductors are disposed inward of a coil forming region in plan view, the end portions of the coil conductors connected to the through-hole conductors protrude inward of the coil, thereby substantially reducing the coil inner diameter. The reduction in the coil inner diameter makes it difficult to achieve sufficient coil characteristics. In the first coil and the second coil, since the plurality of coil conductors are directly connected to each other, the reduction in the coil inner diameter can be suppressed. Therefore, sufficient coil characteristics can be easily achieved.

(2) The multilayer inductor according to (1) above may further include: a first external terminal to which a first end of the first coil and a first end of the second coil are connected; and a second external terminal to which a second end of the first coil and a second end of the second coil are connected.

(3) In the multilayer inductor according to (2) above, the first coil may include a coil axis spaced apart from the first external terminal and the second external terminal when viewed in the lamination direction, and the second coil may include a coil axis spaced apart from the first external terminal and the second external terminal when viewed in the lamination direction. In this case, since no terminals are disposed in the direction of the coil axis, the flow of magnetic flux is unlikely to be obstructed. Therefore, magnetic saturation is suppressed.

(4) The multilayer inductor according to (1) above may further include: a first external terminal to which a first end of the first coil is connected; a second external terminal to which a second end of the first coil is connected; a third external terminal to which a first end of the second coil is connected; and a fourth external terminal to which a second end of the second coil is connected. In this case, the bonding coefficient between the first coil and the second coil improves, which thereby improves the inductance.

(5) In the multilayer inductor according to (4) above, the first coil may include a coil axis spaced apart from the first external terminal, the second external terminal, the third external terminal, and the fourth external terminal when viewed in the lamination direction, and the second coil may include a coil axis spaced apart from the first external terminal, the second external terminal, the third external terminal, and the fourth external terminal when viewed in the lamination direction. In this case, since no terminals are disposed in the direction of the coil axis, the flow of magnetic flux is unlikely to be obstructed. Therefore, magnetic saturation is suppressed.

(6) In the multilayer inductor according to (1) to (4) above, the first coil and the second coil may share a coil axis along the lamination direction, and the first coil conductor and the second coil conductor may be disposed in point symmetry with respect to the coil axis when viewed in the lamination direction. In this case, the first coil conductor and the second coil conductor can be efficiently disposed.

### BRIEF DESCRIPTION OF THE DRAWINGS

FIG. 1 is a perspective view of a multilayer inductor according to a first embodiment.

FIG. 2 is a perspective view illustrating an inner structure of the multilayer inductor of FIG. 1.

FIG. 3 is an exploded view of the multilayer inductor of FIG. 1.

FIG. 4 is a perspective view of a multilayer inductor according to a second embodiment.

FIG. 5 is a perspective view of a multilayer inductor according to a third embodiment.

FIG. 6 is a plan view of the multilayer inductor of FIG. 5.

FIG. 7 is an exploded view of the multilayer inductor of FIG. 5.

FIG. 8 is a plan view of a multilayer inductor according to a fourth embodiment.

FIG. 9 is an exploded view of the multilayer inductor of FIG. 8.

FIG. 10 is a plan view of a multilayer inductor according to a fifth embodiment.

FIG. 11 is an exploded view of the multilayer inductor of FIG. 10.

### DETAILED DESCRIPTION

Embodiments of the present disclosure will be described in detail below with reference to the accompanying drawings. Same reference signs are given to the same or corresponding elements in the description of the drawings, and redundant description will be omitted.

### First Embodiment

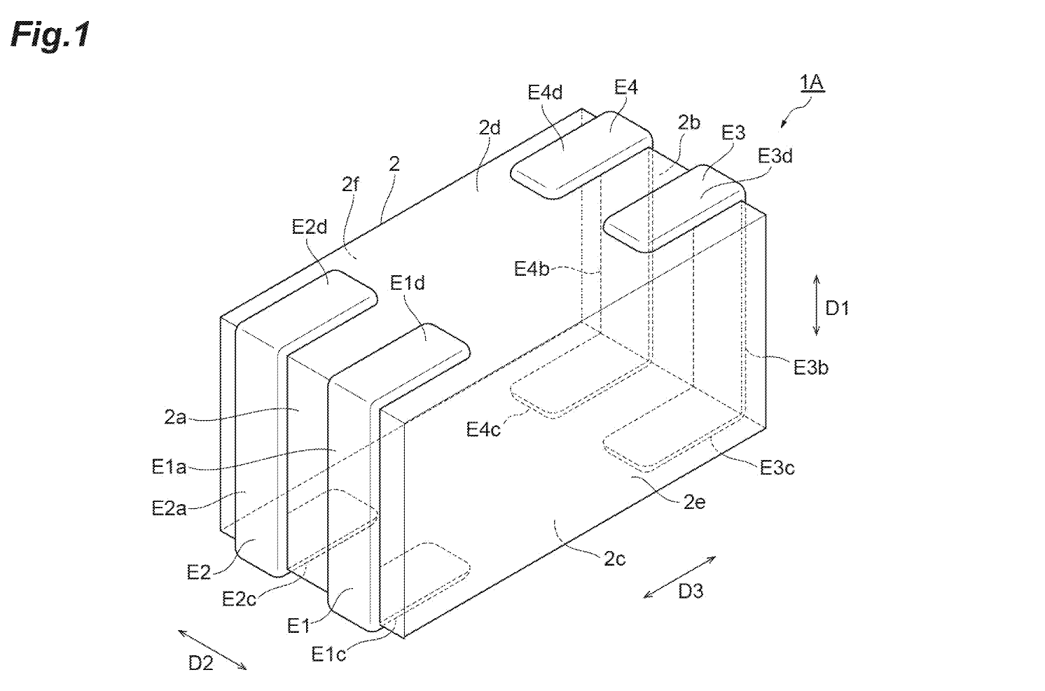

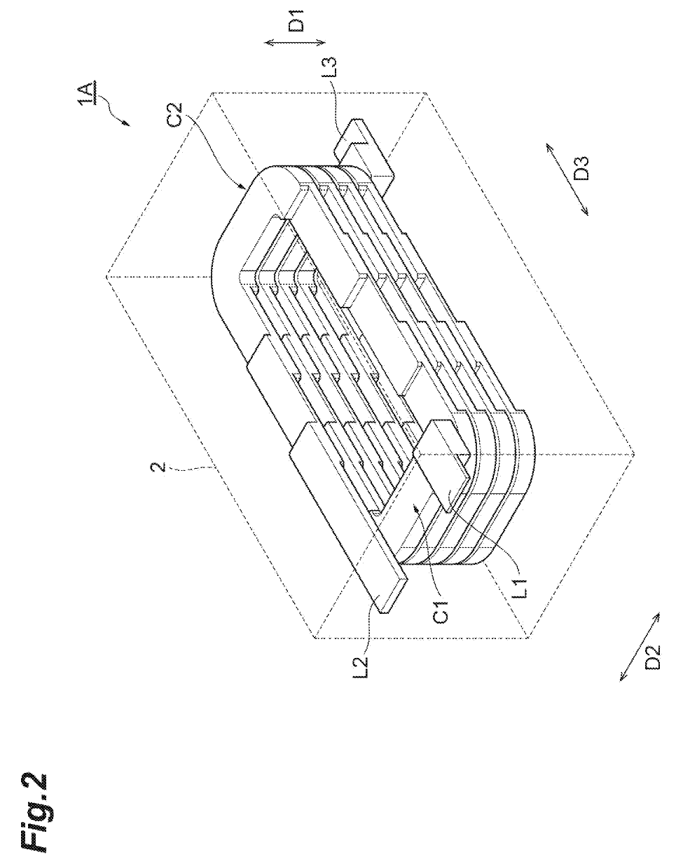

A multilayer inductor 1A according to a first embodiment will be described with reference to FIGS. 1 to 3. As illustrated in FIGS. 1 to 3, the multilayer inductor 1A includes an element body 2, coils C1, C2, connecting conductors L1, L2, L3, L4 (hereinafter, connecting conductors L1 to L4), and external terminals E1, E2, E3, E4 (hereinafter, external terminals E1 to E4). The coils C1, C2 and the connecting conductors L1 to L4 are inner conductors and are disposed inside the element body 2. The multilayer inductor 1A can be applied, for example, to a bead inductor or a power inductor.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. The element body 2 has, as outer surfaces thereof, end surfaces 2a, 2b that face each other, main surfaces 2c, 2d that face each other, and side surfaces 2e, 2f that face each other.

Hereinafter, the facing direction between the main surfaces 2c, 2d is a first direction D1, the facing direction between the side surfaces 2e, 2f is a second direction D2, and the facing direction between the end surfaces 2a, 2b is a third direction D3. The first direction D1, the second direction D2, and the third direction D3 intersect (in this embodiment, are perpendicular to) each other. The first direction D1 is a height direction of the element body 2. The second direction D2 is a width direction of the element body 2. The third direction D3 is a longitudinal direction of the element body 2.

The end surfaces 2a, 2b extend in the first direction D1 so as to connect the main surfaces 2c, 2d. The end surfaces 2a, 2b extend in the second direction D2 so as to connect the side surfaces 2e, 2f. The main surfaces 2c, 2d extend in the third direction D3 so as to connect the end surfaces 2a, 2b. The main surfaces 2c,2d extend in the second direction D2 so as to connect the side surfaces 2e, 2f. The side surfaces 2e,2f extend in the third direction D3 so as to connect the end surfaces 2a, 2b. The side surfaces 2e, 2f extend in the first direction D1 so as to connect the main surfaces 2c, 2d.

The element body 2 has a height (length in the first direction D1) and a width (length in the second direction D2) that are less than a length (length in the third direction D3) of the element body 2. The height and the width of the element body 2 are, for example, equal to each other. The height of the element body 2 is, for example, 0.05 mm or more and 2.00 mm or less. The width of the element body 2 is, for example, 0.05 mm or more and 3.00 mm or less. The length of the element body 2 is, for example, 0.10 mm or more and 3.50 mm or less. The height and the width of the element body 2 may be greater than or equal to the length of the element body 2. The height of the element body 2 may be greater than or less than the width of the element body 2.

The main surface 2c is, for example, the surface (mounting surface) that faces an electronic device not shown when the multilayer inductor 1A is mounted on the electronic device. The electronic device includes, for example, a circuit board or an electronic component. The end surfaces 2a, 2b and the side surfaces 2e, 2f are each a surface adjacent to the main surface 2c. The second direction D2 and the third direction D3 are each a direction along the main surface 2c. The first direction D1 is a direction that intersects (in this embodiment, is perpendicular to) the main surface 2c.

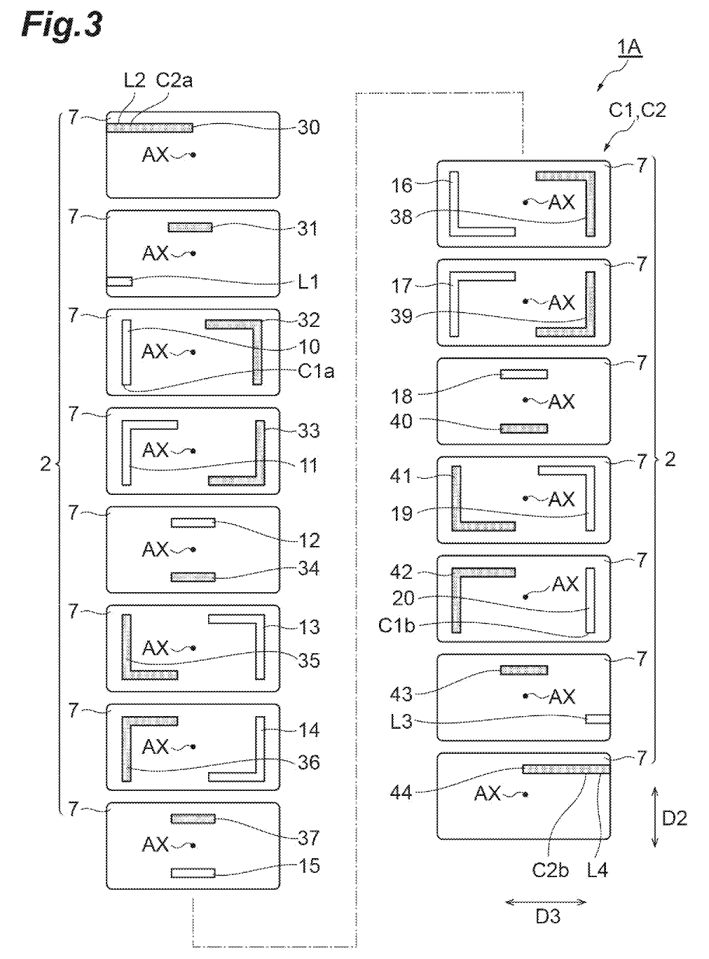

The element body 2 has a plurality of element body layers 7 that are laminated in the first direction D1. A lamination direction of the plurality of element body layers 7 is the first direction D1. The element body 2 is formed by the plurality of element body layers 7 being laminated in the first direction D1. In an actual element body 2, the plurality of element body layers 7 are integrated such that the boundaries between the layers thereof cannot be visually recognized. In FIG. 3, the illustration of the element body layers 7 that are disposed on both end portions in the lamination direction to function as cover layers and cover the inner conductors is omitted. The number of the element body layers 7 disposed on each end portion is, for example, six.

The element body layers 7 are, in this embodiment, magnetic layers and include a plurality of metallic magnetic particles. The metallic magnetic particles are formed, for example, of a soft magnetic alloy. The soft magnetic alloy is, for example, an Fe-Si-based alloy. In the case in which the soft magnetic alloy is an Fe-Si-based alloy, the soft magnetic alloy may include P. The soft magnetic alloy may be, for example, an Fe-Ni-Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements. The element body layers 7 may be nonmagnetic layers and may include a nonmagnetic material. Examples of the nonmagnetic material include a glass ceramic material and a dielectric material.

The element body 2 includes a resin. The resin is present between the plurality of metallic magnetic particles. The resin is a resin having electrical insulating properties (insulating resin). The insulating resin includes, for example, a silicone resin, a phenol resin, an acrylic resin, or an epoxy resin.

The external terminals E1 to E4 are disposed on both end portions of the element body 2 in the third direction D3. The external terminals E1 to E4 have the same shape. The external terminals E1 to E4 are spaced apart from the side surfaces 2e, 2f. The external terminals E1, E2 are disposed on the end surface 2a spaced apart from each other in the second direction D2. The external terminals E3, E4 are disposed on the end surface 2b spaced apart from each other in the second direction D2.

The external terminal E1 is disposed closer to the side surface 2e than is the external terminal E2. The external terminal E2 is disposed closer to the side surface 2f than is the external terminal E1. The external terminal E3 is disposed closer to the side surface 2e than is the external terminal E4. The external terminal E4 is disposed closer to the side surface 2f than is the external terminal E3. The external terminals E1, E3 face each other in the third direction D3. The external terminals E2, E4 face each other in the third direction D3.

The external terminals E1, E2 include electrode portions E1a, E2a disposed on the end surface 2a, electrode portions E1c, E2c disposed on the main surface 2c, and electrode portions E1d, E2d disposed on the main surface 2d. In the external terminal E1, the three electrode portions E1a, E1c, E1d are integrally formed. In the external terminal E2, the three electrode portions E2a, E2c, E2d are integrally formed.

The electrode portions E1a, E2a extend in the first direction D1 and cover the end surface 2a over the entire extent in the first direction D1. The electrode portions E1c, E2c extend in the third direction D3 from one end portions of the electrode portions E1a, E2a in the first direction D1 and cover portions of the main surface 2c in the third direction D3. The electrode portions E1d, E2d extend along the third direction D3 from the other end portions of the electrode portions E1a, E2a in the first direction D1 and cover portions of the main surface 2d in the third direction D3. The electrode portions E1c, E2c face the electrode portions E1d, E2d in the first direction D1.

The external terminals E3, E4 include electrode portions E3b, E4b disposed on the end surface 2b, electrode portions E3c, E4c disposed on the main surface 2c, and electrode portions E3d, E4d disposed on the main surface 2d. In the external terminal E3, the three electrode portions E3b, E3c, E3d are integrally formed. In the external terminal E4, the three electrode portions E4b, E4c, E4d are integrally formed.

The electrode portions E3b, E4b extend in the first direction D1 and cover the end surface 2b over the entire extent in the first direction D1. The electrode portions E3c, E4c extend along the third direction D3 from one end portions of the electrode portions E3b, E4b in the first direction D1 and cover portions of the main surface 2c in the third direction D3. The electrode portions E3d, E4d extend along the third direction D3 from the other end portions of the electrode portions E3b, E4b in the first direction D1 and cover portions of the main surface 2d in the third direction D3. The electrode portions E3c, E4c face the electrode portions E3d, E4d in the first direction D1.

The external terminals E1 to E4 include a conductive material. The conductive material is, for example, Ag or Pd. The external terminals E1 to E4 are formed as sintered bodies of a conductive paste. The conductive paste includes a conductive metal powder and glass frit. The conductive metal powder is, for example, an Ag powder or a Pd powder. A plating layer is formed on the surfaces of the external terminals E1 to E4. The plating layer is formed, for example, by electroplating. The electroplating is, for example, electrolytic Ni plating or electrolytic Sn plating.

The coils C1, C2 share a coil axis AX extending in the first direction D1. The coil axis AX is perpendicular to the main surfaces 2c, 2d. The coil axis AX extends along the end surfaces 2a, 2b and the side surfaces 2e, 2f. The coil axis AX is disposed so as to pass through the center of gravity of the element body 2. The coil axis AX is spaced apart from the external terminals E1 to E4 when viewed in the first direction D1. The coil axis AX is spaced apart from the external terminals E1 to E4 also when viewed in the second direction D2 and the third direction D3. The coil axis AX is also spaced apart from the connecting conductors L1 to L4 when viewed in the first direction D1.

The coils C1, C2 have the same shape when viewed in the first direction D1. The coils C1, C2 have a rectangular ring shape when viewed in the first direction D1. The coils C1, C2 have a length in the third direction D3 greater than a length of the coils C1, C2 in the second direction D2. The coils C1, C2 overlap each other when viewed in the first direction D1. Each of the coils C1, C2 is disposed inside the element body 2, spaced apart from the outer surfaces of the element body 2. Each of the coils C1, C2 is disposed at equal distances from the end surfaces 2a, 2b. Each of the coils C1, C2 is disposed at equal distances from the main surfaces 2c, 2d. Each of the coils C1, C2 is disposed at equal distances from the side surfaces 2e, 2f. The coil C1 has a length in the first direction D1 less than a length of the coil C2 in the first direction D1. The coil C2 is disposed closer to the main surface 2c than is the coil C1. The coil C2 is disposed closer to the main surface 2d than is the coil C1. The coils C1, C2 overlap in the first direction D1. That is, at least a portion of the coil C1 in the first direction D1 is disposed at the same height position in the first direction D1 as at least a portion of the coil C2 in the first direction D1.

The coil C1 has a first end C1a connected to the connecting conductor L1 and a second end C1b connected to the connecting conductor L3. The coil C1 has a plurality of coil conductors 10, 11, 12, 13, 14, 15, 16, 17, 18, 19, 20 (hereinafter, coil conductors 10 to 20) connected to each other. Each of the coil conductors 10 to 20 is provided to extend through a corresponding one of the element body layers 7, and has the same thickness as the element body layer 7.

The coil C1 is formed by the coil conductors 10 to 20 being connected in this order. The coil conductors 10 to 20 are disposed inside the element body 2 arranged in this order in the first direction D1. Among the coil conductors 10 to 20, the coil conductor 10 is disposed closest to the main surface 2d and the coil conductor 20 is disposed closest to the main surface 2c. The coil conductor 10 has the first end C1a of the coil C1 and is connected to the connecting conductor L1. The coil conductor 20 has the second end C1b of the coil C1 and is connected to the connecting conductor L3.

The coil conductors 10 to 20 are directly connected to each other without using conductors such as through-hole conductors. Each of the coil conductors 10 to 20 has an overlapping region with the coil conductor adjacent in the first direction D1 when viewed in the first direction D1, and is directly connected to the adjacent coil conductor in the overlapping region. The coil conductors 10, 11, 12, 13, 14, 15, 16 form one turn of the coil C1.

The coil conductor 10 and the connecting conductor L1 are provided in the element body layers 7 adjacent to each other. The coil conductor 10 and the connecting conductor L1 are directly connected to each other without using a conductor such as a through-hole conductor. The coil conductor 10 has an overlapping region with the connecting conductor L1 when viewed in the first direction D1, and is directly connected to the connecting conductor L1 in the overlapping region.

The coil conductor 20 and the connecting conductor L3 are provided in the element body layers 7 adjacent to each other. The coil conductor 20 and the connecting conductor L3 are directly connected to each other without using a conductor such as a through-hole conductor. The coil conductor 20 has an overlapping region with the connecting conductor L3 when viewed in the first direction D1, and is directly connected to the connecting conductor L3 in the overlapping region.

In the coil conductors 10 to 20, the proportion of the overlapping regions in the conductor portions extending in the second direction D2 is higher than the proportion of the overlapping regions in the conductor portions extending in the third direction D3. In the coil conductors 10 to 20, the conductor portions extending in the second direction D2 are formed entirely of the overlapping regions. In the coil C1, coil portions extending in the second direction D2 are formed entirely of two coil conductors (conductor layers) laminated in the first direction D1, which can thereby reduce the direct current (DC) resistance.

The coil C2 has a first end C2a connected to the connecting conductor L2 and a second end C2b connected to the connecting conductor L4. The coil C2 has a plurality of coil conductors 30, 31, 32, 33, 34, 35, 36, 37, 38, 39, 40, 41, 42, 43, 44 (hereinafter, coil conductors 30 to 44) connected to each other. Each of the coil conductors 30 to 44 is provided to extend through a corresponding one of the element body layers 7, and has the same thickness as the element body layer 7.

The coil C2 is formed by the coil conductors 30 to 44 being connected in this order. The coil conductors 30 to 44 are disposed inside the element body 2 arranged in this order in the first direction D1. Among the coil conductors 30 to 44, the coil conductor 30 is disposed closest to the main surface 2d and the coil conductor 44 is disposed closest to the main surface 2c. The coil conductor 30 has the first end C2a of the coil C2 and is connected to the connecting conductor L2. The coil conductor 44 has the second end C2b of the coil C2 and is connected to the connecting conductor L4.

The coil conductors 30 to 44 are directly connected to each other without using conductors such as through-hole conductors. Each of the coil conductors 30 to 44 has an overlapping region with the coil conductor adjacent in the first direction D1 when viewed in the first direction D1, and is directly connected to the adjacent coil conductor in the overlapping region. The coil conductors 30, 31, 32, 33, 34, 35 form one turn of the coil C2. The coil conductors 36, 37, 38, 39, 40, 41 form the next turn of the coil C2.

The coil conductor 30 and the connecting conductor L2 are provided in the same element body layer 7. The coil conductor 30 and the connecting conductor L2 are integrally formed, and have a linear shape extending in the third direction D3 from the end surface 2a along the side surface 2f when viewed in the first direction D1. The coil conductor 44 and the connecting conductor L4 are provided in the same element body layer 7. The coil conductor 44 and the connecting conductor L4 are integrally formed, and have a linear shape extending in the third direction D3 from the end surface 2b along the side surface 2f when viewed in the first direction D1.

In the coil conductors 30 to 44, the proportion of the overlapping regions in the conductor portions extending in the second direction D2 is higher than the proportion of the overlapping regions in the conductor portions extending in the third direction D3. In the coil conductors 30 to 44, the conductor portions extending in the second direction D2 are formed entirely of the overlapping regions. In the coil C2, coil portions extending in the second direction D2 are formed entirely of two coil conductors (conductor layers) laminated in the first direction D1, which can thereby reduce the DC resistance.

The coil conductor 31 and the connecting conductor L1 are provided in the same element body layer 7. The coil conductors 10, 32 are provided in the same element body layer 7. Similarly, each of the pairs of the coil conductors 11, 33, the coil conductors 12, 34, the coil conductors 13, 35, the coil conductors 14, 36, the coil conductors 15, 37, the coil conductors 16, 38, the coil conductors 17, 39, the coil conductors 18, 40, the coil conductors 19, 41, and the coil conductors 20, 42 is provided in the same element body layer 7. The coil conductor 43 and the connecting conductor L3 are provided in the same element body layer 7. In this embodiment, the expression that a plurality of conductors are provided in the same element body layer 7 is synonymous with the plurality of conductors being disposed at the same height position in the first direction D1.

The coil conductors 11, 33 are disposed in point symmetry with respect to the coil axis AX when viewed in the first direction D1. Similarly, each of the pairs of the coil conductors 12, 34, the coil conductors 13, 35, the coil conductors 14, 36, the coil conductors 15, 37, the coil conductors 16, 38, the coil conductors 17, 39, the coil conductors 18, 40, and the coil conductors 19, 41 is disposed in point symmetry with respect to the coil axis AX when viewed in the first direction D1. Accordingly, disposing a pair of coil conductors in point symmetry enables the pair of coil conductors to be efficiently disposed.

The connecting conductor L1 is exposed on the end surface 2a and connected to the electrode portion E1a of the external terminal E1. The connecting conductor L1 connects the coil C1 and the external terminal E1. The connecting conductor L2 is exposed on the end surface 2a and connected to the electrode portion E2a of the external terminal E2. The connecting conductor L2 connects the coil C2 and the external terminal E2. The connecting conductor L3 is exposed on the end surface 2b and connected to the electrode portion E3b of the external terminal E3. The connecting conductor L3 connects the coil C1 and the external terminal E3. The connecting conductor L4 is exposed on the end surface 2b and connected to the electrode portion E4b of the external terminal E4. The connecting conductor L4 connects the coil C2 and the external terminal E4.

Each of the coil conductors 10 to 20, the coil conductors 30 to 44, and the connecting conductors L1 to L4 has a flat shape over the entire length thereof. That is, no step is formed in the first direction D1 between both end portions of each conductor. Each conductor is disposed at the same height position in the first direction D1 over the entire length thereof. Both end portions of each conductor are disposed at the same height position in the first direction D1. Each conductor includes a conductive material (e.g., Ag or Pd). Each conductor is formed as a sintered body of a conductive paste including a conductive material (e.g., an Ag powder or a Pd powder). The coil conductors 10 to 20, the coil conductors 30 to 44, and the connecting conductors L1 to L4 are formed, for example, of the same conductive material.

As described above, in the multilayer inductor 1A, the coils C1, C2 overlap in the lamination direction (first direction D1). Thus, the bonding coefficient between the coils C1, C2 is improved and approaches 1 compared to a configuration in which the coils C1, C2 are arranged in the lamination direction without overlapping. Therefore, the inductance can be improved. In the coil C1, since the coil conductors 10 to 20 are directly connected to each other, the reduction in the coil inner diameter can be suppressed compared to a configuration in which the coil conductors 10 to 20 are connected via conductors such as through-hole conductors. Therefore, sufficient coil characteristics can be easily achieved. In the coil C2, since the plurality of the coil conductors 30 to 44 are directly connected to each other, the reduction in the coil inner diameter can be suppressed compared to a configuration in which the coil conductors 30 to 44 are connected via conductors such as through-hole conductors. Therefore, sufficient coil characteristics can be easily achieved.

### Second Embodiment

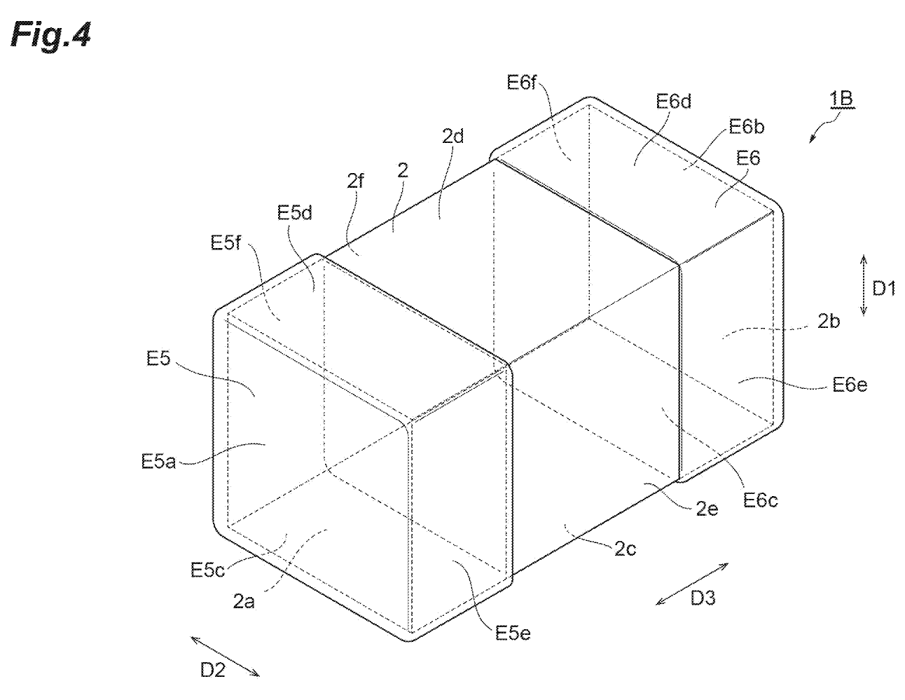

A multilayer inductor 1B according to a second embodiment will be described with reference to FIG. 4. As illustrated in this figure, the multilayer inductor 1B is different from the multilayer inductor 1A according to the first embodiment in that it includes external terminals E5, E6 instead of the external terminals E1 to E4. The inner conductors of the multilayer inductor 1B have the same configuration as the inner conductors of the multilayer inductor 1A. That is, the multilayer inductor 1B has the coils C1, C2 and the connecting conductors L1 to L4. The multilayer inductor 1B will be described below mainly in terms of differences from the multilayer inductor 1A.

The external terminals E5, E6 are disposed on both end portions of the element body 2 in the third direction D3. The external terminals E5, E6 have the same shape. The external terminals E5, E6 are spaced apart from each other in the third direction D3. The external terminals E5, E6 face each other in the third direction D3. The external terminals E5, E6 are formed of the same material as that of the external terminals E1 to E4.

The external terminal E5 includes an electrode portion E5a disposed on the end surface 2a, an electrode portion E5c disposed on the main surface 2c, an electrode portion E5d disposed on the main surface 2d, an electrode portion E5e disposed on the side surface 2e, and an electrode portion E5f disposed on the side surface 2f. The electrode portion E5a covers the entirety of the end surface 2a. The electrode portions E5c, E5d cover portions of the main surfaces 2c, 2d in the third direction D3, respectively. The electrode portions E5e, E5f cover portions of the side surfaces 2e, 2f in the third direction D3, respectively. In the external terminal E5, the five electrode portions E5a, E5c, E5d, E5e, E5f are integrally formed.

The external terminal E6 includes an electrode portion E6b disposed on the end surface 2b, an electrode portion E6c disposed on the main surface 2c, an electrode portion E6d disposed on the main surface 2d, an electrode portion E6e disposed on the side surface 2e, and an electrode portion E6f disposed on the side surface 2f. The electrode portion E6b covers the entirety of the end surface 2b. The electrode portions E6c, E6d cover portions of the main surfaces 2c, 2d in the third direction D3, respectively. The electrode portions E6e, E6f cover portions of the side surfaces 2e, 2f in the third direction D3, respectively. In the external terminal E6, the five electrode portions E6b, E6c, E6d, E6e, E6f are integrally formed.

The electrode portion E5a of the external terminal E5 is connected to the first end C1a of the coil C1 by the connecting conductor L1 and connected to the first end C2a of the coil C2 by the connecting conductor L2. The connecting conductor L1 connects the coil C1 and the external terminal E5. The connecting conductor L2 connects the coil C2 and the external terminal E5. Since the connecting conductors L1, L2 are each directly connected to the external terminal E5, the DC resistance can be reduced. The electrode portion E6b of the external terminal E6 is connected to the second end C1b of the coil C1 by the connecting conductor L3 and connected to the second end C2b of the coil C2 by the connecting conductor L4. The connecting conductor L3 connects the coil C1 and the external terminal E6. The connecting conductor L4 connects the coil C2 and the external terminal E6. Since the connecting conductors L3, L4 are each directly connected to the external terminal E6, the DC resistance can be reduced.

As described above, the inner conductors of the multilayer inductor 1B have the same configuration as the inner conductors of the multilayer inductor 1A illustrated in FIGS. 1 to 3. The coil axis AX common to the coils C1, C2 is spaced apart from the external terminals E5, E6 when viewed in the first direction D1. The coil axis AX is spaced apart from the external terminals E5, E6 also when viewed in the second direction D2. The coil axis AX overlaps with the external terminals E5, E6 when viewed in the third direction D3. The coil axis AX is spaced apart from the connecting conductors L1 to L4 when viewed in the third direction D3.

Since the coils C1, C2 overlap in the lamination direction (first direction D1) also in the multilayer inductor 1B, the inductance can be improved. In the coil C1, since the coil conductors 10 to 20 are directly connected to each other, the reduction in the coil inner diameter can be suppressed. Therefore, sufficient coil characteristics can be easily achieved. In the coil C2, since the coil conductors 30 to 44 are directly connected to each other, the reduction in the coil inner diameter can be suppressed. Therefore, sufficient coil characteristics can be easily achieved.

### Third Embodiment

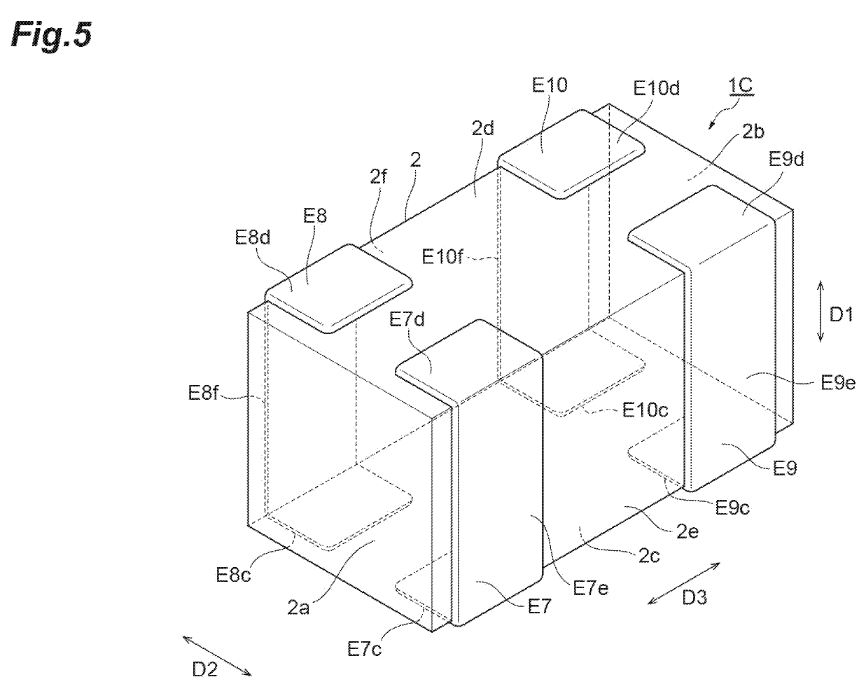

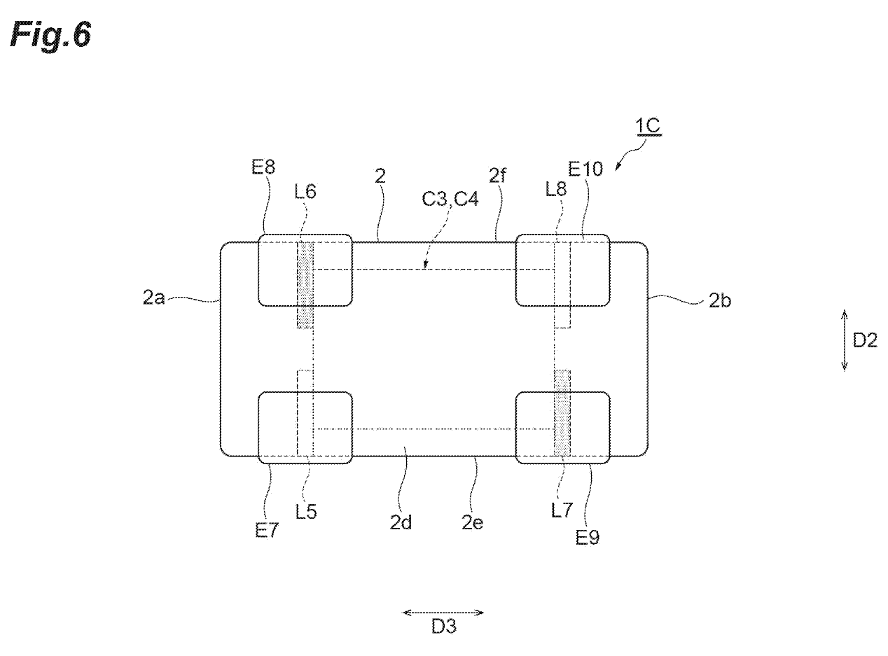

A multilayer inductor 1C according to a third embodiment will be described with reference to FIGS. 5 to 7. As illustrated in FIGS. 5 to 7, the multilayer inductor 1C includes the element body 2, coils C3, C4, connecting conductors L5, L6, L7, L8 (hereinafter, connecting conductors L5 to L8), and external terminals E7, E8, E9, E10 (hereinafter, external terminals E7 to E10). The multilayer inductor 1C is different from the multilayer inductor 1A in that it includes the coils C3, C4 instead of the coils C1, C2, the connecting conductors L5 to L8 instead of the connecting conductors L1 to L4, and the external terminals E7 to E10 instead of the external terminals E1 to E4. The multilayer inductor 1C will be described below mainly in terms of differences from the multilayer inductor 1A.

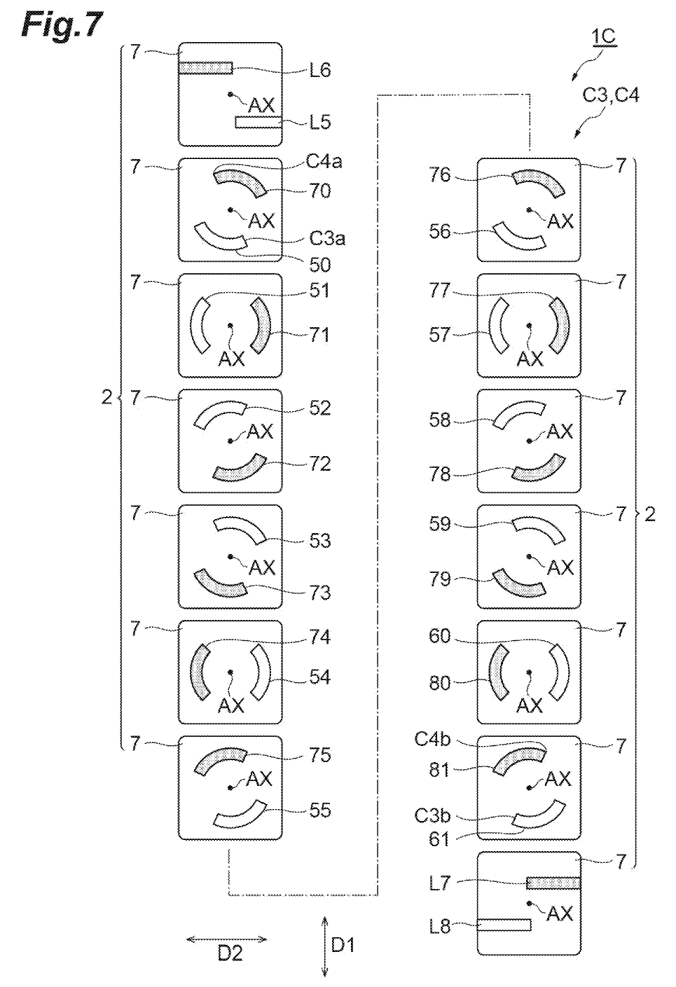

The element body 2 has the plurality of element body layers 7 that are laminated in the third direction D3. The lamination direction of the plurality of element body layers 7 is the third direction D3. The element body 2 is formed by the plurality of element body layers 7 being laminated in the third direction D3. In an actual element body 2, the plurality of element body layers 7 are integrated such that the boundaries between the layers thereof cannot be visually recognized. In FIG. 7, the illustration of the element body layers 7 that are disposed on both end portions in the lamination direction to function as cover layers and cover the inner conductors is omitted. The number of the element body layers 7 disposed on each end portion is, for example, six.

The external terminals E7 to E10 are disposed on both end portions of the element body 2 in the second direction D2. The external terminals E7 to E10 have the same shape. The external terminals E7 to E10 are spaced apart from the end surfaces 2a, 2b. The external terminals E7, E9 are disposed on the side surface 2e spaced apart from each other in the third direction D3. The external terminals E8, E10 are disposed on the side surface 2f spaced apart from each other in the third direction D3. The external terminals E7 to E10 are, for example, formed of the same material as that of the external terminals E1 to E4.

The external terminal E7 is disposed closer to the end surface 2a than is the external terminal E9. The external terminal E9 is disposed closer to the end surface 2b than is the external terminal E7. The external terminal E8 is disposed closer to the end surface 2a than is the external terminal E10. The external terminal E10 is disposed closer to the end surface 2b than is the external terminal E8. The external terminals E7, E8 face each other in the second direction D2. The external terminals E9, E10 face each other in the second direction D2.

The external terminals E7, E9 include electrode portions E7e, E9e disposed on the side surface 2e, electrode portions E7c, E9c disposed on the main surface 2c, and electrode portions E7d, E9d disposed on the main surface 2d. In the external terminal E7, the three electrode portions E7e, E7c, E7d are integrally formed. In the external terminal E9, the three electrode portions E9e, E9c, E9d are integrally formed.

The electrode portions E7e, E9e extend in the first direction D1 and cover the side surface 2e over the entire extent in the first direction D1. The electrode portions E7c, E9c extend in the second direction D2 from one end portions of the electrode portions E7e, E9e in the first direction D1 and cover portions of the main surface 2c in the second direction D2. The electrode portions E7d, E9d extend in the second direction D2 from the other end portions of the electrode portions E7e, E9e in the first direction D1 and cover portions of the main surface 2d in the second direction D2. The electrode portions E7c, E9c face the electrode portions E7d, E9d in the first direction D1.

The external terminals E8, E10 include electrode portions E8f, E10f disposed on the side surface 2f, electrode portions E8c, E10c disposed on the main surface 2c, and electrode portions E8d, E10d disposed on the main surface 2d. In the external terminal E8, the three electrode portions E8f, E8c, E8d are integrally formed. In the external terminal E10, the three electrode portions E10f, E10c, E10d are integrally formed.

The electrode portions E8f, E10f extend in the first direction D1 and cover the side surface 2f over the entire extent in the first direction D1. The electrode portions E8c, E10c extend in the second direction D2 from one end portions of the electrode portions E8f, E10f in the first direction D1 and cover portions of the main surface 2c in the second direction D2. The electrode portions E8d, E10d extend in the second direction D2 from the other end portions of the electrode portions E8f, E10f in the first direction D1 and cover portions of the main surface 2d in the second direction D2. The electrode portions E8c, E10c face the electrode portions E8d, E10d in the first direction D1.

The coils C3, C4 share the coil axis AX extending in the third direction D3. The coil axis AX is perpendicular to the end surfaces 2a, 2b. The coil axis AX extends along the main surfaces 2c, 2d and the side surfaces 2e, 2f. The coil axis AX is disposed so as to pass through the center of gravity of the element body 2. The coil axis AX is spaced apart from the external terminals E7 to E10 when viewed in the third direction D3. The coil axis AX is spaced apart from the external terminals E7 to E10 also when viewed in the first direction D1. The coil axis AX overlaps with the external terminals E7 to E10 when viewed in the second direction D2. The coil axis AX is spaced apart from the connecting conductors L5 to L8 when viewed in the third direction D3.

The coils C3, C4 have the same shape (an annular shape in this embodiment) when viewed in the third direction D3. The coils C3, C4 overlap each other when viewed in the third direction D3. Each of the coils C3, C4 is disposed inside the element body 2, spaced apart from outer surfaces of the element body 2. Each of the coils C3, C4 is disposed at equal distances from the end surfaces 2a, 2b. Each of the coils C3, C4 is disposed at equal distances from the main surfaces 2c, 2d. Each of the coils C3, C4 is disposed at equal distances from the side surfaces 2e, 2f. The coil C3 has a length in the third direction D3 equal to a length of the coil C4 in the third direction D3. The coils C3, C4 overlap in the third direction D3. That is, at least a portion of the coil C3 in the third direction D3 is disposed at the same height position in the third direction D3 as at least a portion of the coil C4 in the third direction D3. The entirety of the coil C3 in the third direction D3 is disposed at the same height position in the third direction D3 as the entirety of the coil C4 in the third direction D3.

The coil C3 has a first end C3a connected to the connecting conductor L5 and a second end C3b connected to the connecting conductor L8. The coil C3 has a plurality of coil conductors 50, 51, 52, 53, 54, 55, 56, 57, 58, 59, 60, 61 (hereinafter, coil conductors 50 to 61) connected to each other. Each of the coil conductors 50 to 61 is provided to extend through a corresponding one of the element body layers 7, and has the same thickness as the element body layer 7.

The coil C3 is formed by the coil conductors 50 to 61 being connected in this order. The coil conductors 50 to 61 are disposed inside the element body 2 arranged in this order in the third direction D3. Among the coil conductors 50 to 61, the coil conductor 50 is disposed closest to the end surface 2a and the coil conductor 61 is disposed closest to the end surface 2b. The coil conductor 50 has the first end C3a of the coil C3 and is connected to the connecting conductor L5. The coil conductor 61 has the second end C3b of the coil C3 and is connected to the connecting conductor L8.

The coil conductors 50 to 61 are directly connected to each other without using conductors such as through-hole conductors. Each of the coil conductors 50 to 61 has an overlapping region with the coil conductor adjacent in the third direction D3 when viewed in the third direction D3, and is directly connected to the adjacent coil conductor in the overlapping region. The coil conductors 50 to 61 form the coil C3 by repetition of six pattern shapes. The coil conductors 50, 51, 52, 53, 54, 55 form one turn of the coil C3. The coil conductors 56, 57, 58, 59, 60, 61 form the next turn of the coil C3.

The coil conductor 50 and the connecting conductor L5 are provided in the element body layers 7 adjacent to each other. The coil conductor 50 and the connecting conductor L5 are directly connected to each other without using a conductor such as a through-hole conductor. The coil conductor 50 has an overlapping region with the connecting conductor L5 when viewed in the third direction D3, and is directly connected to the connecting conductor L5 in the overlapping region.

The coil conductor 61 and the connecting conductor L8 are provided in the element body layers 7 adjacent to each other. The coil conductor 61 and the connecting conductor L8 are directly connected to each other without using a conductor such as a through-hole conductor. The coil conductor 61 has an overlapping region with the connecting conductor L8 when viewed in the third direction D3, and is directly connected to the connecting conductor L8 in the overlapping region.

The coil C4 has a first end C4a connected to the connecting conductor L6 and a second end C4b connected to the connecting conductor L7. The coil C4 has a plurality of coil conductors 70, 71, 72, 73, 74, 75, 76, 77, 78, 79, 80, 81 (hereinafter, coil conductors 70 to 81) connected to each other. Each of the coil conductors 70 to 81 is provided to extend through a corresponding one of the element body layers 7, and has the same thickness as the element body layer 7.

The coil C4 is formed by the coil conductors 70 to 81 being connected in this order. The coil conductors 70 to 81 are disposed inside the element body 2 arranged in this order in the third direction D3. Among the coil conductors 70 to 81, the coil conductor 70 is disposed closest to the end surface 2a and the coil conductor 81 is disposed closest to the end surface 2b. The coil conductor 70 has the first end C4a of the coil C4 and is connected to the connecting conductor L6. The coil conductor 81 has the second end C4b of the coil C4 and is connected to the connecting conductor L7.

The coil conductors 70 to 81 are directly connected to each other without using conductors such as through-hole conductors. Each of the coil conductors 70 to 81 has an overlapping region with the coil conductor adjacent in the third direction D3 when viewed in the third direction D3, and is directly connected to the adjacent coil conductor in the overlapping region.

The coil conductor 70 and the connecting conductor L6 are provided in the element body layers 7 adjacent to each other. The coil conductor 70 and the connecting conductor L6 are directly connected to each other without using a conductor such as a through-hole conductor. The coil conductor 70 has an overlapping region with the connecting conductor L6 when viewed in the third direction D3, and is directly connected to the connecting conductor L6 in the overlapping region.

The coil conductor 81 and the connecting conductor L7 are provided in the element body layers 7 adjacent to each other. The coil conductor 81 and the connecting conductor L7 are directly connected to each other without using a conductor such as a through-hole conductor. The coil conductor 81 has an overlapping region with the connecting conductor L7 when viewed in the third direction D3, and is directly connected to the connecting conductor L7 in the overlapping region.

The coil conductors 50 to 61, 70 to 81 have the shape of an arc of a sector centered on the coil axis AX when viewed in the third direction D3. The central angles of the sectors corresponding to the coil conductors 50 to 61, 70 to 81 are equal and are, for example, 100 degrees. The coil conductors 50 to 61, 70 to 81 have rotational symmetry about the coil axis AX when viewed in the third direction D3. The coil conductors 50 to 61, 70 to 81 have the same shape.

The connecting conductors L5, L6 are provided in the same element body layer 7. Similarly, each of the pairs of the coil conductors 50, 70, the coil conductors 51, 71, the coil conductors 52, 72, the coil conductors 53, 73, the coil conductors 54, 74, the coil conductors 55, 75, the coil conductors 56, 76, the coil conductors 57, 77, the coil conductors 58, 78, the coil conductors 59, 79, the coil conductors 60, 80, the coil conductors 61, 81, and the connecting conductors L7, L8 is provided in the same element body layer 7. In this embodiment, the expression that a plurality of conductors are provided in the same element body layer 7 is synonymous with the plurality of conductors being disposed at the same height position in the third direction D3.

The connecting conductors L5, L6 are disposed in point symmetry with respect to the coil axis AX when viewed in the third direction D3. Similarly, each of the pairs of the coil conductors 50, 70, the coil conductors 51, 71, the coil conductors 52, 72, the coil conductors 53, 73, the coil conductors 54, 74, the coil conductors 55, 75, the coil conductors 56, 76, the coil conductors 57, 77, the coil conductors 58, 78, the coil conductors 59, 79, the coil conductors 60, 80, the coil conductors 61, 81, and the connecting conductors L7, L8 is disposed in point symmetry with respect to the coil axis AX when viewed in the third direction D3.

The connecting conductor L5 is exposed on the side surface 2e and connected to the electrode portion E7e of the external terminal E7. The connecting conductor L5 connects the coil C3 and the external terminal E7. The connecting conductor L6 is exposed on the side surface 2f and connected to the electrode portion E8f of the external terminal E8. The connecting conductor L6 connects the coil C4 and the external terminal E8. The connecting conductor L7 is exposed on the side surface 2e and connected to the electrode portion E9e of the external terminal E9. The connecting conductor L7 connects the coil C4 and the external terminal E9. The connecting conductor L8 is exposed on the side surface 2f and connected to the electrode portion E10f of the external terminal E10. The connecting conductor L8 connects the coil C3 and the external terminal E10.

Each of the coil conductors 50 to 61, the coil conductors 70 to 81, and the connecting conductors L5 to L8 has a flat shape over the entire length thereof. That is, no step is formed in the third direction D3 between both end portions of each conductor. Each conductor is disposed at the same height position in the third direction D3 over the entire length thereof. Both end portions of each conductor are disposed at the same height position in the third direction D3. Each conductor includes a conductive material (e.g., Ag or Pd). Each conductor is formed as a sintered body of a conductive paste including a conductive material (e.g., an Ag powder or a Pd powder). The coil conductors 50 to 61, the coil conductors 70 to 81, and the connecting conductors L5 to L8 are formed, for example, of the same conductive material.

Since the coils C3, C4 overlap in the lamination direction (third direction D3) also in the multilayer inductor 1C, the bonding coefficient between the coils C3, C4 is improved and approaches 1, which can thereby improve the inductance. In the coil C3, since the coil conductors 50 to 61 are directly connected to each other, the reduction in the coil inner diameter can be suppressed. Therefore, sufficient coil characteristics can be easily achieved. In the coil C4, since the coil conductors 70 to 81 are directly connected to each other, the reduction in the coil inner diameter can be suppressed. Therefore, sufficient coil characteristics can be easily achieved.

### Fourth Embodiment

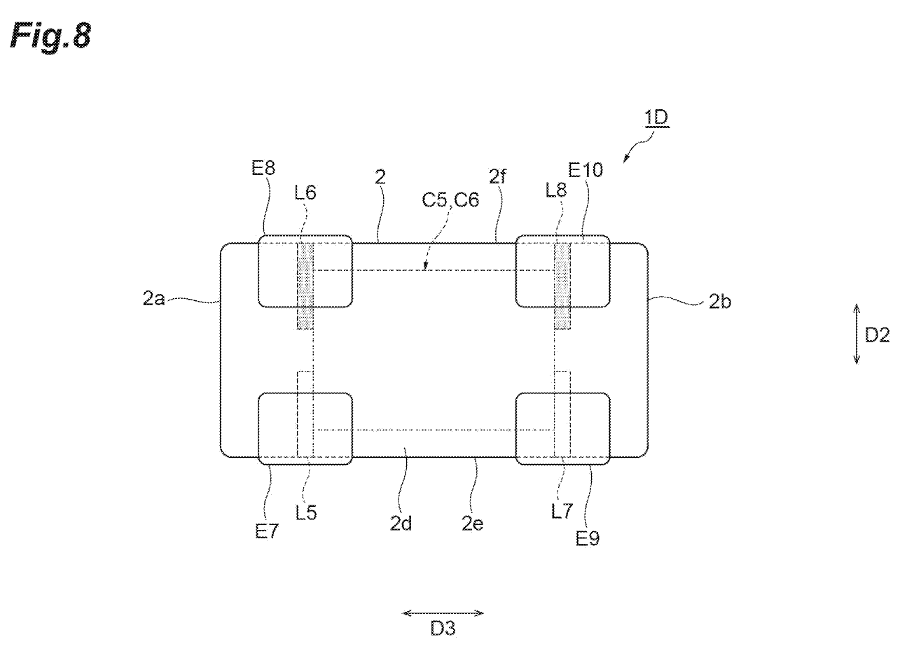

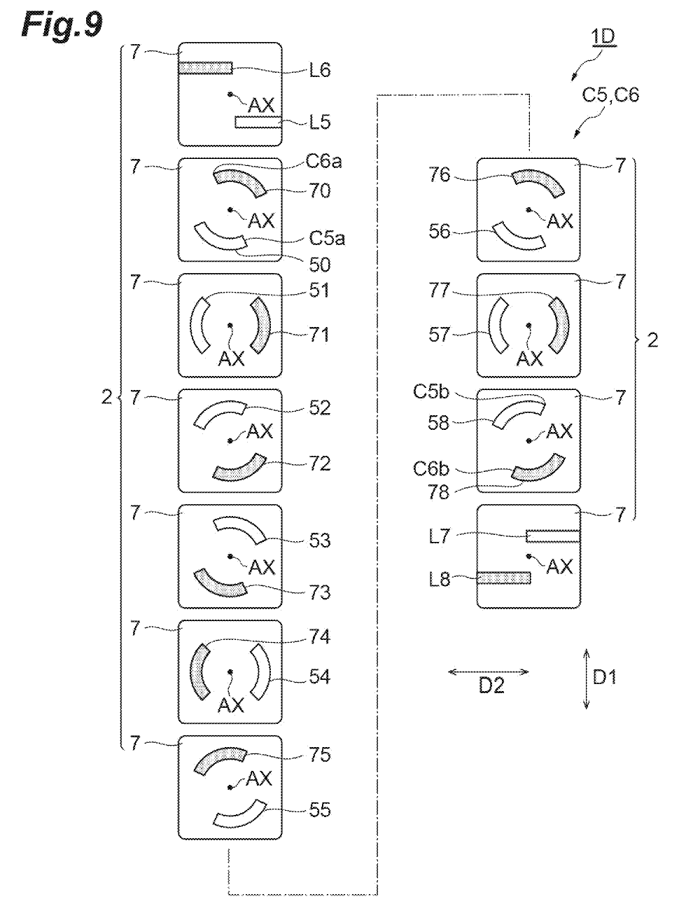

A multilayer inductor 1D according to a fourth embodiment will be described with reference to FIGS. 8 and 9. As illustrated in FIGS. 8 and 9, the multilayer inductor 1D is different from the multilayer inductor 1C in that it includes coils C5, C6 instead of the coils C3, C4. The coils C5, C6 have a smaller number of turns than the coils C3, C4. The multilayer inductor 1D will be described below mainly in terms of differences from the multilayer inductor 1C.

The coil C5 is different from the coil C3 in that it does not have the coil conductors 59, 60, 61. The number of turns of the coil C5 is less than the number of turns of the coil C3. The coil C5 has the coil conductors 50, 51, 52, 53, 54, 55, 56, 57, 58 (hereinafter, the coil conductors 50 to 58). Among the coil conductors 50 to 58, the coil conductor 50 is disposed closest to the end surface 2a and the coil conductor 58 is disposed closest to the end surface 2b. The coil C5 has a length in the third direction D3 equal to a length of the coil C6 in the third direction D3. The coils C5, C6 overlap in the third direction D3. That is, at least a portion of the coil C5 in the third direction D3 is disposed at the same height position in the third direction D3 as at least a portion of the coil C6 in the third direction D3. The entirety of the coil C5 in the third direction D3 is disposed at the same height position in the third direction D3 as the entirety of the coil C6 in the third direction D3.

The coil C5 has a first end C5a connected to the connecting conductor L5 and a second end C5b connected to the connecting conductor L7. The coil conductor 50 has the first end C5a of the coil C5 and is connected to the connecting conductor L5. The coil conductor 58 has the second end C5b of the coil C5 and is connected to the connecting conductor L7.

The coil C6 is different from the coil C4 in that it does not have the coil conductors 79, 80, 81. The number of turns of the coil C6 is less than the number of turns of the coil C4. The coil C6 has the coil conductors 70, 71, 72, 73, 74, 75, 76, 77, 78 (hereinafter, the coil conductors 70 to 78). Among the coil conductors 70 to 78, the coil conductor 70 is disposed closest to the end surface 2a and the coil conductor 78 is disposed closest to the end surface 2b.

The coil C6 has a first end C6a connected to the connecting conductor L6 and a second end C6b connected to the connecting conductor L8. The coil conductor 70 has the first end C6a of the coil C6 and is connected to the connecting conductor L6. The coil conductor 78 has the second end C6b of the coil C6 and is connected to the connecting conductor L8.

The shapes and arrangements of the connecting conductors L5 to L8 are the same as those of the multilayer inductor 1C. The connecting conductor L5 is exposed on the side surface 2e and connected to the electrode portion E7e of the external terminal E7. The connecting conductor L5 connects the coil C5 and the external terminal E7. The connecting conductor L6 is exposed on the side surface 2f and connected to the electrode portion E8f of the external terminal E8. The connecting conductor L6 connects the coil C6 and the external terminal E8. The connecting conductor L7 is exposed on the side surface 2e and connected to the electrode portion E9e of the external terminal E9. The connecting conductor L7 connects the coil C5 and the external terminal E9. The connecting conductor L8 is exposed on the side surface 2f and connected to the electrode portion E10f of the external terminal E10. The connecting conductor L8 connects the coil C6 and the external terminal E10.

Since the coils C5, C6 overlap in the lamination direction (third direction D3) also in the multilayer inductor 1D, the bonding coefficient between the coils C5, C6 is improved and approaches 1, which can thereby improve the inductance. In the coil C5, since the coil conductors 50 to 58 are directly connected to each other, the reduction in the coil inner diameter can be suppressed. Therefore, sufficient coil characteristics can be easily achieved. In the coil C6, since the coil conductors 70 to 78 are directly connected to each other, the reduction in the coil inner diameter can be suppressed. Therefore, sufficient coil characteristics can be easily achieved.

### Fifth Embodiment

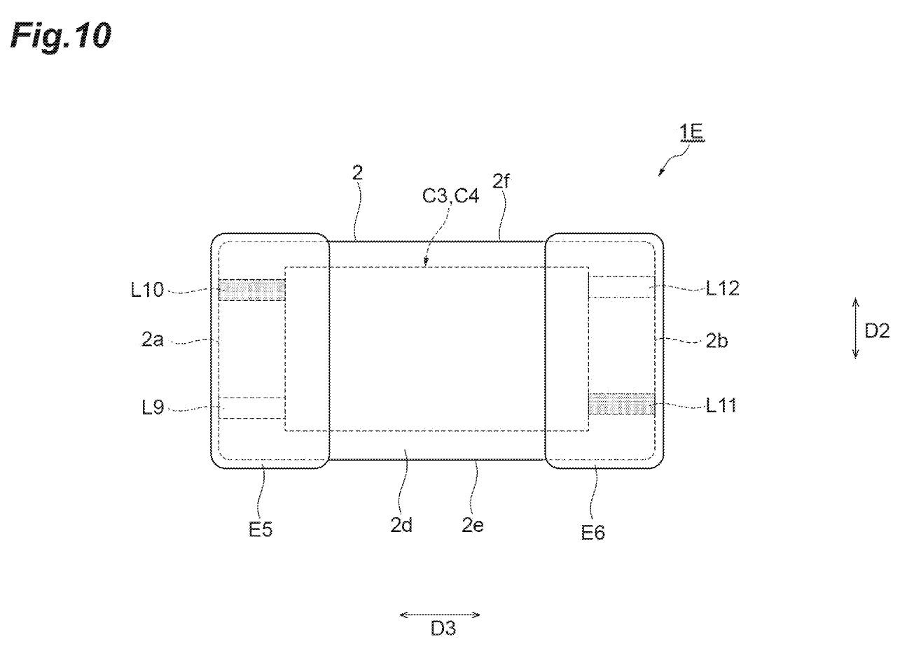

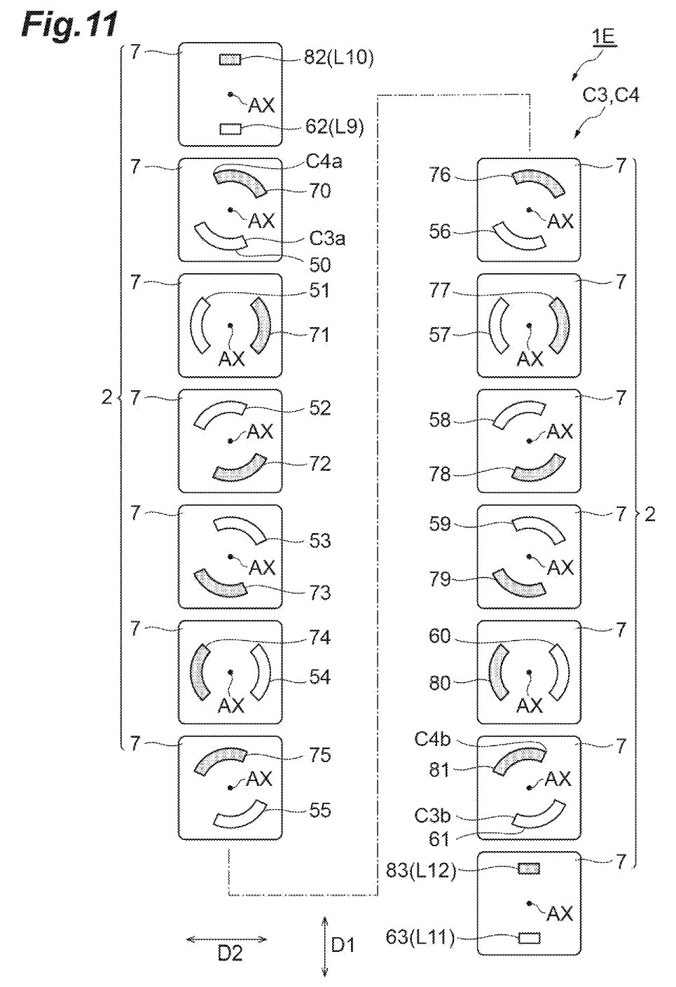

A multilayer inductor 1E according to a fifth embodiment will be described with reference to FIGS. 10 and 11. As illustrated in FIGS. 10 and 11, the multilayer inductor 1E is different from the multilayer inductor 1C in that it includes the external terminals E5, E6 instead of the external terminals E7 to E10. The configuration of the external terminals E5, E6 is the same as that of the multilayer inductor 1B. The multilayer inductor 1E is also different from the multilayer inductor 1C in that it includes connecting conductors L9 to L12 instead of the connecting conductors L5 to L8. The multilayer inductor 1E will be described below mainly in terms of differences from the multilayer inductor 1C.

The connecting conductors L9 to L12 extend along the third direction D3. The connecting conductor L9 has a plurality of conductor layers 62 which are laminated in the third direction D3. The connecting conductor L10 has a plurality of conductor layers 82 which are laminated in the third direction D3. The connecting conductor L11 has a plurality of conductor layers 63 which are laminated in the third direction D3. The connecting conductor L12 has a plurality of conductor layers 83 which are laminated in the third direction D3. Each of the conductor layers 62, 63, 82, 83 is provided to extend through a corresponding one of the element body layers 7, and has the same thickness as the element body layer 7.

The connecting conductors L9, L10 are exposed on the end surface 2a and connected to the electrode portion E5a of the external terminal E5. The connecting conductor L9 connects the coil C3 and the external terminal E5. The connecting conductor L10 connects the coil C4 and the external terminal E5. Since the connecting conductors L9, L10 are each directly connected to the external terminal E5, the DC resistance can be reduced. The connecting conductors L11, L12 are exposed on the end surface 2b and connected to the electrode portion E6b of the external terminal E6. The connecting conductor L11 connects the coil C3 and the external terminal E6. The connecting conductor L12 connects the coil C4 and the external terminal E6. Since the connecting conductors L11, L12 are each directly connected to the external terminal E6, the DC resistance can be reduced.

The connecting conductor L9 (conductor layers 62), the connecting conductor L10 (conductor layers 82), the connecting conductor L11 (conductor layers 63), and the connecting conductor L12 (conductor layers 83) include a conductive material (e.g. Ag or Pd). The connecting conductors L9 to L12 are formed as sintered bodies of a conductive paste including a conductive material (e.g., an Ag powder or a Pd powder). The coil conductors 50 to 61, the coil conductors 70 to 81, and the connecting conductors L9 to L12 are formed, for example, of the same conductive material. In this embodiment, the coil axis AX common to the coils C3, C4 overlaps with the external terminals E5, E6 when viewed from each of the first direction D1, the second direction D2, and the third direction D3. The coil axis AX is spaced apart from the connecting conductors L9 to L11 when viewed in the third direction D3.

Since the coils C3, C4 overlap in the lamination direction (third direction D3) also in the multilayer inductor 1E, the inductance can be improved. In the coil C3, since the coil conductors 50 to 61 are directly connected to each other, the reduction in the coil inner diameter can be suppressed. Therefore, sufficient coil characteristics can be easily achieved. In the coil C4, since the coil conductors 70 to 81 are directly connected to each other, the reduction in the coil inner diameter can be suppressed. Therefore, sufficient coil characteristics can be easily achieved.

Although the embodiments have been described above, the present disclosure is not necessarily limited to these embodiments, and various modifications are possible without departing from the gist thereof.

Although the coils C1, C2 share the coil axis AX in the multilayer inductors 1A, 1B, they may have different coil axes along the lamination direction (first direction D1). The coils C1, C2 may have different shapes when viewed in the first direction D1. The coils C1, C2 may have the same length in the first direction D1.

Although the coils C3, C4 share the coil axis AX in the multilayer inductors 1C, 1E, they may have different coil axes along the lamination direction (third direction D3). The coils C3, C4 may have different shapes when viewed in the third direction D3. The coils C3, C4 may have different lengths in the third direction D3.

Although the coils C5, C6 share the coil axis AX in the multilayer inductor 1D, they may have different coil axes along the lamination direction (third direction D3). The coils C5, C6 may have different shapes when viewed in the third direction D3. The coils C5, C6 may have different lengths in the third direction D3.

In the multilayer inductor 1A, the external terminal E1 need not have the electrode portion E1d. The external terminal E2 need not have the electrode portion E2d. The external terminal E3 need not have the electrode portion E3d. The external terminal E4 need not have the electrode portion E4d.

In the multilayer inductors 1B, 1E, it is only required that the external terminal E5 has at least the electrode portions E5a, E5c. It is only required that the external terminal E6 has at least the electrode portions E6b, E6c.

In the multilayer inductors 1C, 1D, the external terminal E7 need not have the electrode portion E7d. The external terminal E8 need not have the electrode portion E8d. The external terminal E9 need not have the electrode portion E9d. The external terminal E10 need not have the electrode portion E10d.

The multilayer inductors 1C, 1D may include the external terminals E5, E6 instead of the external terminals E7 to E10. In this case, the connecting conductor L5 is exposed on the side surface 2e and connected to the electrode portion E5e of the external terminal E5. The connecting conductor L6 is exposed on the side surface 2f and connected to the electrode portion E5f of the external terminal E5. The connecting conductor L7 is exposed on the side surface 2e and connected to the electrode portion E6e of the external terminal E6. The connecting conductor L8 is exposed on the side surface 2f and connected to the electrode portion E6f of the external terminal E6.

The embodiments and variations described above may be combined as appropriate.

What is claimed is:

1. A multilayer inductor comprising:
an element body including a plurality of element body layers being laminated;
a first coil including a plurality of coil conductors including a first coil conductor, the plurality of coil conductors being directly connected to each other; and
a second coil including a plurality of coil conductors including a second coil conductor, the plurality of coil conductors being directly connected to each other,
wherein the first coil conductor and the second coil conductor are disposed at a same height position in a lamination direction of the plurality of element body layers.

2. The multilayer inductor according to claim 1, further comprising:
a first external terminal to which a first end of the first coil and a first end of the second coil are connected; and
a second external terminal to which a second end of the first coil and a second end of the second coil are connected.

3. The multilayer inductor according to claim 2,
wherein the first coil includes a coil axis spaced apart from the first external terminal and the second external terminal when viewed in the lamination direction, and
wherein the second coil includes a coil axis spaced apart from the first external terminal and the second external terminal when viewed in the lamination direction.

4. The multilayer inductor according to claim 1, further comprising:
a first external terminal to which a first end of the first coil is connected;
a second external terminal to which a second end of the first coil is connected;
a third external terminal to which a first end of the second coil is connected; and
a fourth external terminal to which a second end of the second coil is connected.

5. The multilayer inductor according to claim 4,
wherein the first coil includes a coil axis spaced apart from the first external terminal, the second external terminal, the third external terminal, and the fourth external terminal when viewed in the lamination direction, and
wherein the second coil includes a coil axis spaced apart from the first external terminal, the second external terminal, the third external terminal, and the fourth external terminal when viewed in the lamination direction.

6. The multilayer inductor according to claim 1,
wherein the first coil and the second coil share a coil axis along the lamination direction, and
wherein the first coil conductor and the second coil conductor are disposed in point symmetry with respect to the coil axis when viewed in the lamination direction.
